(19) United States
(12) Patent Application Publication
(10) Pub. No.: US 2017/0193573 A1
(43) Pub. Date: Jul. 6, 2017

(54) SYSTEM FOR SEARCH QUERY RESULT OPTIMIZATION THROUGH MODELING OF HISTORIC CONSUMER PAYMENT BEHAVIOR AND RELATED METHODS

(71) Applicant: WAL-MART STORES, INC., Bentonville, AR (US)

(72) Inventors: Wei Han, Foster City, CA (US); Parikshit Sondhi, Mountain View, CA (US); Anjan Goswami, Dublin, CA (US)

(73) Assignee: WAL-MART STORES, INC., Bentonville, AR (US)

(21) Appl. No.: 14/986,942

(22) Filed: Jan. 4, 2016

(51) Int. Cl. G06Q 30/02; G06F 17/30; G06Q 30/06

(52) U.S. Cl. CPC G06Q 30/0283; G06Q 30/0625; G06Q 30/0633; G06F 17/3053; G06F 17/30554; G06F 17/3056

(57) ABSTRACT

Some embodiments include a system. The system includes one or more processors, and one or more non-transitory memory storage devices storing computer instructions configured to run on the one or more processors. The computer instructions are configured to perform acts of: making available multiple items for purchase by an instant consumer; receiving a query from the instant consumer; determining an estimated price range; identifying one or more in-range items of the multiple items; identifying one or more out-range items of the multiple items; and facilitating displaying to the instant consumer a list of the multiple items such that the one or more in-range items are listed before the one or more out-range items in the list. Other embodiments of related systems and methods are also provided.

### TECHNICAL FIELD

This disclosure relates generally to systems for search query result optimization, and relates more particularly to systems for search query result optimization through modeling of historic consumer payment behavior and to related methods.

### BACKGROUND

A retailer may offer for sale a variety of items having a variety of prices. Accordingly, the retailer may provide consumers with the option to search the retailer's inventory so that the consumers can determine what items are available and at what prices the items are being sold. Although a variety of items in the retailer's inventory may be relevant to a particular search query, for a variety of reasons, one or more items of the relevant items may be more relevant to a particular consumer than one or more other items of the relevant items. For example, one or more items of the relevant items may be offered for sale at prices above or below what an average consumer would generally be willing to pay when searching for items relating to the particular search query. Accordingly, there is a need for systems and methods for search query result optimization that prioritize items having prices being more relevant to an average consumer.

### BRIEF DESCRIPTION OF THE DRAWINGS

To facilitate further description of the embodiments, the following drawings are provided in which:

FIG. 1 illustrates a front elevational view of an exemplary computer system that is suitable to implement at least part of a central computer system and/or at least part of one or more consumer computer systems of the system of FIG. 3 and/or to implement at least part of one or more of the activities of FIGS. 9-11;

FIG. 2 illustrates a representative block diagram of exemplary elements included on the circuit boards inside a chassis of the computer system of FIG. 1;

FIG. 3 illustrates a representative block diagram of a system, according to an embodiment;

FIG. 4 illustrates a representative block diagram of a central computer system of the system of FIG. 3, according to the embodiment of FIG. 3;

FIG. 5 illustrates a representative block diagram of one or more databases of the system of FIG. 3, according to the embodiment of FIG. 3;

FIG. 6 illustrates a graph of an exemplary density of items viewed by previous consumers for a particular search query as a function of the price of the items;

FIG. 7 illustrates a graph of an exemplary density of items clicked by previous consumers for the particular search query as a function of the price of the items;

FIG. 8 illustrates a graph of an exemplary density of items purchased by previous consumers for the particular search query as a function of the price of the items;

FIG. 9 illustrates a flow chart for a method, according to an embodiment;

FIG. 10 illustrates an exemplary activity of determining an estimated price range, according to the embodiment of FIG. 9; and

FIG. 11 illustrates an exemplary activity of defining the estimated price range based on the previous prices, according to the embodiment of FIG. 9.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

Some embodiments include a system. The system comprises one or more processors and one or more non-transitory memory storage devices storing computer instructions. The computer instructions are configured to run on the one or more processors and perform acts of: making available multiple items for purchase by an instant consumer; receiving a query from the instant consumer, the query being associated with the multiple items; determining an estimated price range; identifying one or more in-range items of the multiple items, the one or more in-range items having one or more in-range item prices, and the estimated price range including the one or more in-range item prices; identifying one or more out-range items of the multiple items, the one or more out-range items having one or more out-range item prices, and the one or more out-range item prices being outside of the estimated price range; and facilitating displaying to the instant consumer a list of the multiple items such that the one or more in-range items are listed before the one or more out-range items in the list.

Other embodiments include a method. The method comprises: executing one or more first computer instructions configured to make available multiple items for purchase by an instant consumer; executing one or more second computer instructions configured to receive a query from the instant consumer, the query being associated with the multiple items; executing one or more third computer instructions configured to determine an estimated price range; executing one or more fourth computer instructions configured to identify one or more in-range items of the multiple items, the one or more in-range items having one or more in-range item prices, and the estimated price range including the one or more in-range item prices; executing one or more fifth computer instructions configured to identify one or more out-range items of the multiple items, the one or more out-range items having one or more out-range item prices, and the one or more out-range item prices being outside of the estimated price range; and executing one or more sixth computer instructions configured to communicate to the instant consumer a list of the multiple items such that the one or more in-range items are listed before the one or more out-range items in the list. Meanwhile, the one or more first computer instructions, the one or more second computer instructions, the one or more third computer instructions, the one or more fourth computer instructions, the one or more fifth computer instructions, and the one or more sixth computer instructions are configured to run at one or more processors and configured to be stored at one or more non-transitory memory storage devices.

Further embodiments include at least one non-transitory memory storage device having computer instructions stored thereon executable by one or more processors to perform acts of: making available multiple items for purchase by an instant consumer; receiving a query from the instant consumer, the query being associated with the multiple items; determining an estimated price range; identifying one or more in-range items of the multiple items, the one or more in-range items having one or more in-range item prices, and the estimated price range including the one or more in-range item prices; identifying one or more out-range items of the multiple items, the one or more out-range items having one or more out-range item prices, and the one or more out-range item prices being outside of the estimated price range; and facilitating displaying to the instant consumer a list of the multiple items such that the one or more in-range items are listed before the one or more out-range items in the list.

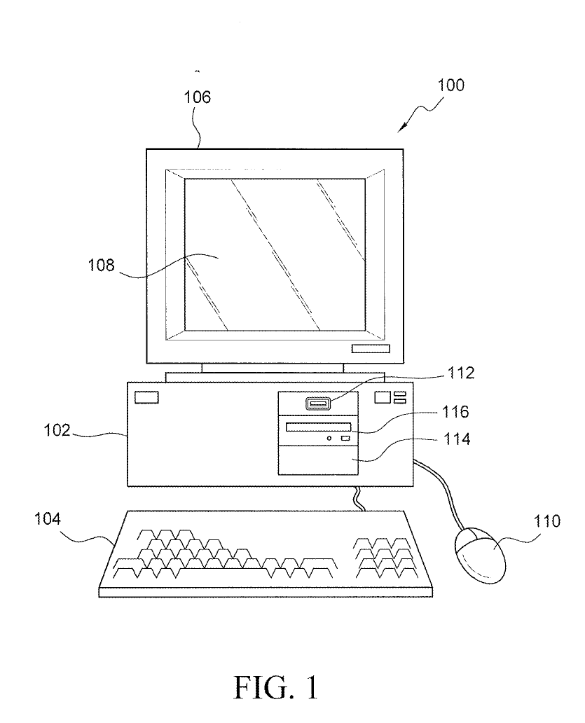

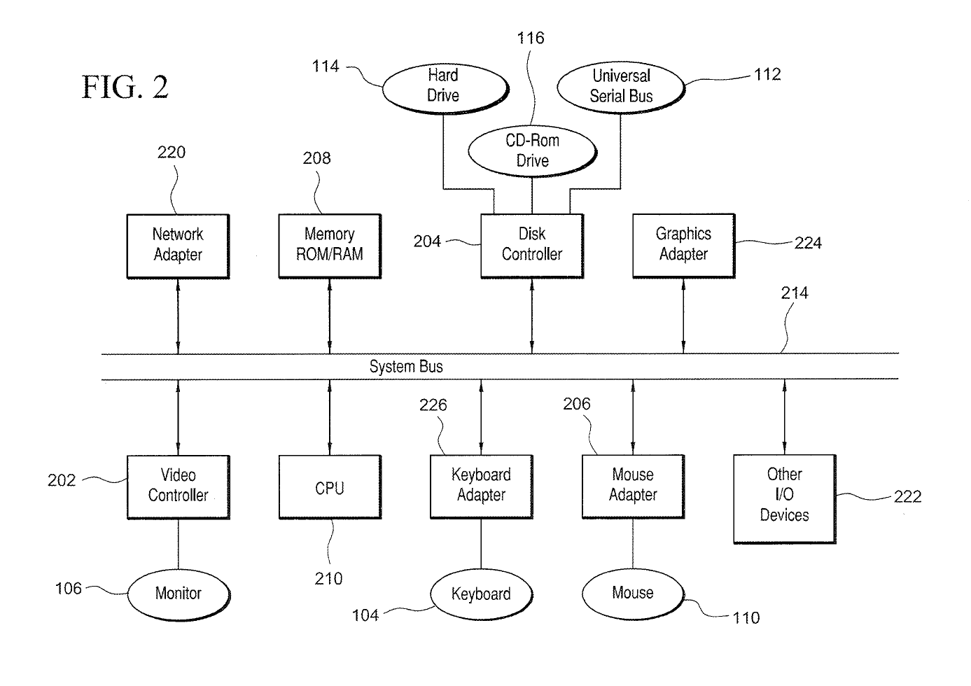

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage devices described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a refreshing monitor 106, a keyboard 104, and/or a mouse 110, etc.) can also be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) volatile (e.g., transitory) memory, such as, for example, read only memory (ROM) and/or (ii) non-volatile (e.g., non-transitory) memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. The memory storage devices(s) of the various embodiments disclosed herein can comprise memory storage unit 208, an external memory storage drive (not shown), such as, for example, a USB-equipped electronic memory storage drive coupled to universal serial bus (USB) port 112 (FIGS. 1-2), hard drive 114 (FIGS. 1-2), CD-ROM and/or DVD drive 116 (FIGS. 1-2), a floppy disk drive (not shown), an optical disc (not shown), a magneto-optical disc (now shown), magnetic tape (not shown), etc. Further, non-volatile or non-transitory memory storage device(s) refer to the portions of the memory storage device(s) that are non-volatile (e.g., non-transitory) memory.

In various examples, portions of the memory storage device(s) of the various embodiments disclosed herein (e.g., portions of the non-volatile memory storage device(s)) can be encoded with a boot code sequence suitable for restoring computer system 100 (FIG. 1) to a functional state after a system reset. In addition, portions of the memory storage device(s) of the various embodiments disclosed herein (e.g., portions of the non-volatile memory storage device(s)) can comprise microcode such as a Basic Input-Output System (BIOS) operable with computer system 100 (FIG. 1). In the same or different examples, portions of the memory storage device(s) of the various embodiments disclosed herein (e.g., portions of the non-volatile memory storage device(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise (i) Microsoft® Windows® operating system (OS) by Microsoft Corp. of Redmond, Wash., United States of America, (ii) Mac® OS by Apple Inc. of Cupertino, Calif., United States of America, (iii) UNIX® OS, and (iv) Linux® OS. Further exemplary operating systems can comprise (i) the iPhone® operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by the Open Handset Alliance, (v) the Windows Mobile™ operating system by Microsoft Corp. of Redmond, Wash., United States of America, or (vi) the Symbian™ operating system by Nokia Corp. of Keilaniemi, Espoo, Finland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage device(s) of the various embodiments disclosed herein can be executed by CPU 210 (FIG. 2). At least a portion of the program instructions, stored on these memory storage device(s), can be suitable for carrying out at least part of the techniques and methods described herein.

Further, although computer system 100 is illustrated as a desktop computer in FIG. 1, in many examples, system 100 can have a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smart phone. In certain additional embodiments, computer system 100 may comprise an embedded system.

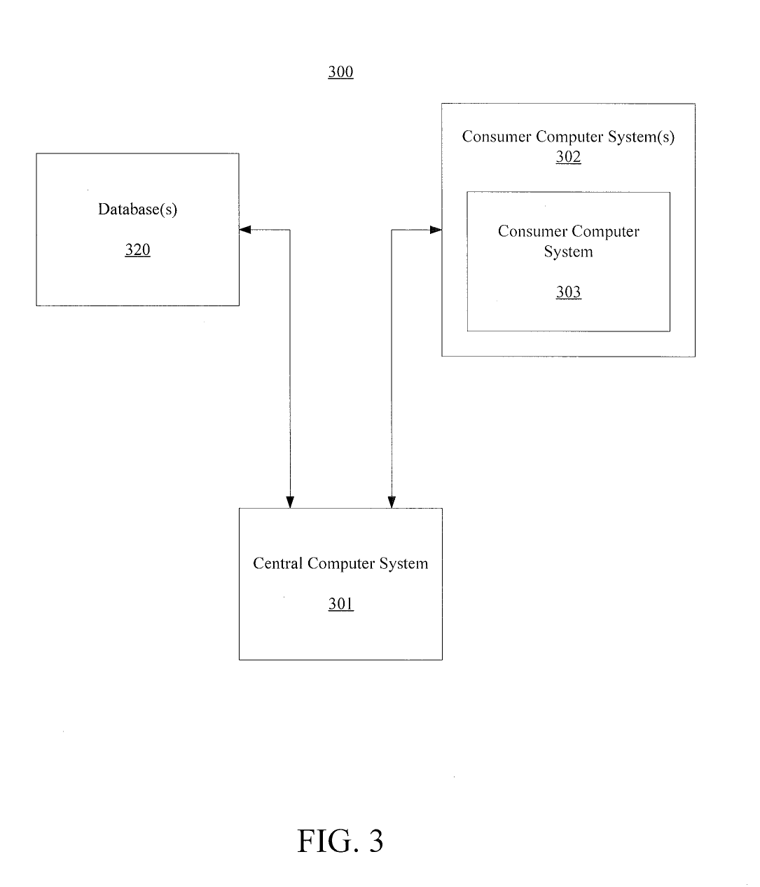

Skipping ahead now in the drawings, FIG. 3 illustrates a representative block diagram of a system 300, according to an embodiment. System 300 is merely exemplary and embodiments of the system are not limited to the embodiments presented herein. System 300 can be employed in many different embodiments or examples not specifically depicted or described herein. In some embodiments, certain elements or modules of system 300 can perform various methods and/or activities of those methods. In these or other embodiments, the methods and/or the activities of the methods can be performed by other suitable elements or sub-systems of system 300.

As described in greater detail below, system 300 can be operable to provide search query result optimization through modeling of historic consumer payment behavior. That is, system 300 can provide more relevant and/or useful search query results to a consumer that provides a search query to search an inventory of items being made available for browsing and purchase, such as, for example, by determining a range of prices paid by previous consumers that provided a similar or same search query and by prioritizing items priced within that range of prices when providing the customer with the search query results.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Specifically, system 300 comprises a central computer system 301. In many embodiments, central computer system 301 can be similar or identical to computer system 100 (FIG. 1). Accordingly, central computer system 301 can comprise one or more processors and one or more memory storage devices (e.g., one or more non-transitory memory storage devices). In these or other embodiments, the processor(s) and/or the memory storage device(s) can be similar or identical to the processor(s) and/or memory storage device(s) (e.g., non-transitory memory storage device(s)) described above with respect to computer system 100 (FIG. 1). In some embodiments, central computer system 301 can comprise a single computer or server, but in many embodiments, central computer system 301 comprises a cluster or collection of computers or servers and/or a cloud of computers or servers. Meanwhile, central computer system 301 can comprise one or more input devices (e.g., one or more keyboards, one or more keypads, one or more pointing devices such as a computer mouse or computer mice, one or more touchscreen displays, etc.), and/or can comprise one or more display devices (e.g., one or more monitors, one or more touch screen displays, etc.). In these or other embodiments, one or more of the input device(s) can be similar or identical to keyboard 104 (FIG. 1) and/or a mouse 110 (FIG. 1). Further, one or more of the display device(s) can be similar or identical to refreshing monitor 106 (FIG. 1) and/or screen 108 (FIG. 1). The input device(s) and the display device(s) can be coupled to the processor(s) and/or the memory storage device(s) of central computer system 301 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage device(s). In some embodiments, the KVM switch also can be part of central computer system 301. In a similar manner, the processor(s) and the memory storage device(s) can be local and/or remote to each other.

In many embodiments, central computer system 301 is configured to communicate with one or more consumer computer systems 302 (e.g., a consumer computer system 303) of one or more consumers. For example, the consumer(s) can interface (e.g., interact) with central computer system 301, and vice versa, via consumer computer system(s) 302 (e.g., consumer computer system 303). Accordingly, in many embodiments, central computer system 301 can refer to a back end of system 300 operated by an operator and/or administrator of system 300, and consumer computer system(s) 302 can refer to a front end of system 300 used by one or more users of system 300 (i.e., the consumer(s)). In these or other embodiments, the operator and/or administrator of system 300 can manage central computer system 301, the processor(s) of computer system 301, and/or the memory storage device(s) of computer system 301 using the input device(s) and/or display device(s) of central computer system 301. In some embodiments, system 300 can comprise consumer computer system(s) 302 (e.g., consumer computer system 303).

Like central computer system 301, consumer computer system(s) 302 each can be similar or identical to computer system 100 (FIG. 1), and in many embodiments, each of consumer computer system(s) 302 can be similar or identical to each other. In many embodiments, consumer computer system(s) 302 can comprise one or more wearable user computer devices and/or one or more mobile electronic devices, etc. At least part of central computer system 301 can be located remotely from consumer computer system(s) 302.

In many embodiments, a mobile electronic device can refer to a portable electronic device (e.g., an electronic device easily conveyable, by hand by a person of average size) with the capability to present audio and/or visual data (e.g., images, videos, music, etc.). For example, a mobile electronic device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), or another portable computer device with the capability to present audio and/or visual data (e.g., images, videos, music, etc.). Thus, in many examples, a mobile electronic device can comprise a volume and/or weight sufficiently small as to permit the mobile electronic device to be easily conveyable by hand. For examples, in some embodiments, a mobile electronic device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile electronic device can weigh less than or equal to 15.6 Newtons, 17.8 Newtons, 22.3 Newtons, 31.2 Newtons, and/or 44.5 Newtons.

Exemplary mobile electronic devices can comprise (i) an iPod®, iPhone®, iTouch®, iPad®, MacBook® or similar item by Apple Inc. of Cupertino, Calif., United States of America, (ii) a Blackberry® or similar item by Research in Motion (RIM) of Waterloo, Ontario, Canada, (iii) a Lumia® or similar item by the Nokia Corporation of Keilaniemi, Espoo, Finland, and/or (iv) a Galaxy™ or similar item by the Samsung Group of Samsung Town, Seoul, South Korea. Further, in the same or different embodiments, a mobile electronic device can comprise an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by the Open Handset Alliance, (v) the Windows Mobile™ operating system by Microsoft Corp. of Redmond, Wash., United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ or a similar item by Google Inc. of Menlo Park, Calif., United States of America; (ii) the Eye Tap™, the Laser Eye Tap™, or a similar item by ePI Lab of Toronto, Ontario, Canada, and/or (iii) the Raptyr™, the STAR1200™, the Vuzix Smart Glasses M100™, or a similar item by Vuzix Corporation of Rochester, N.Y., United States of America. In other specific examples, a head mountable wearable user computer device can comprise the Virtual Retinal Display™, or similar item by the University of Washington of Seattle, Wash., United States of America. Meanwhile, in further specific examples, a limb mountable wearable user computer device can comprise the iWatch™, or similar item by Apple Inc. of Cupertino, Calif., United States of America, and/or the Zip™, One™, Flex™, Charge™, Surge™ or similar item by Fitbit Inc. of San Francisco, Calif., United States of America.

In further embodiments, central computer system 301 can be configured to communicate with software (e.g., one or more web browsers, one or more mobile software applications, etc.) of the consumer computer system(s) 302 (e.g., consumer computer system 303). For example, the software can run on one or more processors and can be stored on one or more memory storage devices (e.g., one or more non-transitory memory storage devices) of the consumer computer system(s) 302 (e.g., consumer computer system 303). In these or other embodiments, the processor(s) of the consumer computer system(s) 302 (e.g., consumer computer system 303) can be similar or identical to the processor(s) described above with respect to computer system 100 (FIG. 1). Further, the memory storage device(s) (e.g., non-transitory memory storage modules) of the consumer computer system(s) 302 (e.g., consumer computer system 303) can be similar or identical to the memory storage device(s) (e.g., non-transitory memory storage device(s)) described above with respect to computer system 100 (FIG. 1). Exemplary web browsers can include (i) Firefox® by the Mozilla Organization of Mountain View, Calif., United States of America, (ii) Internet Explorer® by the Microsoft Corp. of Redmond, Wash., United States of America, (iii) Chrome™ by Google Inc. of Menlo Park, Calif., United States of America, (iv) Opera® by Opera Software of Oslo, Norway, and (v) Safari® by Apple Inc. of Cupertino, Calif., United States of America. Using the software of the consumer computer system(s) 302, the consumer(s) operating consumer computer system(s) 302 can leverage the functionality of system 300 discussed herein, such as, for example, to receive optimized search query results based on modeled historic consumer payment behavior.

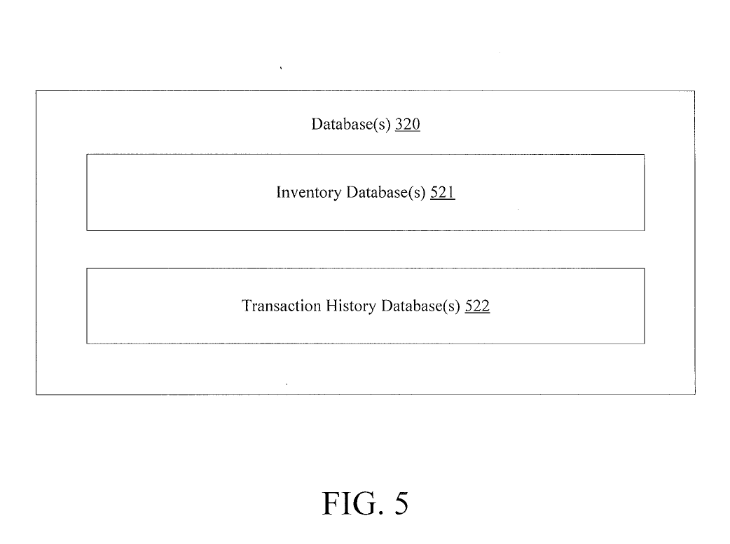

Meanwhile, in many embodiments, central computer system 301 also can be configured to communicate with one or more databases 320 (e.g., one or more inventory databases 521 (FIG. 5), one or more transaction history databases 522 (FIG. 5), etc.). Database(s) 320 can be stored on one or more memory storage modules (e.g., non-transitory memory storage device(s)), which can be similar or identical to the one or more memory storage device(s) (e.g., non-transitory memory storage device(s)) described above with respect to computer system 100 (FIG. 1). Also, in some embodiments, for any particular database of database(s) 320, that particular database can be stored on a single memory storage device of the memory storage device(s) and/or the non-transitory memory storage device(s) storing database(s) 320 or it can be spread across multiple of the memory storage device(s) and/or non-transitory memory storage device(s) storing database(s) 320, depending on the size of the particular database and/or the storage capacity of the memory storage device(s) and/or non-transitory memory storage device(s).

In these or other embodiments, the memory storage device(s) of central computer system 300 can comprise some or all of the memory storage device(s) storing database(s) 320. In further embodiments, some of the memory storage device(s) storing database(s) 320 can be part of consumer computer systems 302 and/or one or more third-party computer systems (i.e., other than central computer system 301 and consumer computer systems 302), and in still further embodiments, all of the memory storage device(s) storing database(s) 320 can be part of consumer computer systems 302 and/or the third-party computer system(s). Like central computer system 301 and consumer computer system(s) 302, when applicable, each of the third-party computer system(s) can be similar or identical to computer system 100 (FIG. 1). Notably, the third-party computer systems are omitted from the drawings to better illustrate that database(s) 320 can be stored at memory storage device(s) of central computer system 301, consumer computer system(s) 302, and/or the third-party computer systems, depending on the manner in which system 300 is implemented.

Database(s) 320 each can comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Items) Database and IBM DB2 Database.

Meanwhile, communication between central computer system 301, consumer computer system(s) 302 (e.g., consumer computer system 303), and/or database(s) 320 can be implemented using any suitable manner of wired and/or wireless communication. Accordingly, system 300 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), Powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3, IEEE 802.11, etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/Time Division Multiple Access (TDMA)), Integrated Digital Enhanced Network (iDEN), etc. The specific communication software and/or hardware implemented can depend on the network topologies and/or protocols implemented, and vice versa. In many embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.

For convenience, the functionality of system 300 is generally described herein as it relates particularly to consumer computer system 303 and a single consumer, but in many embodiments, the functionality of system 300 can be extended to each of consumer computer system(s) 302 and/or to multiple consumers.

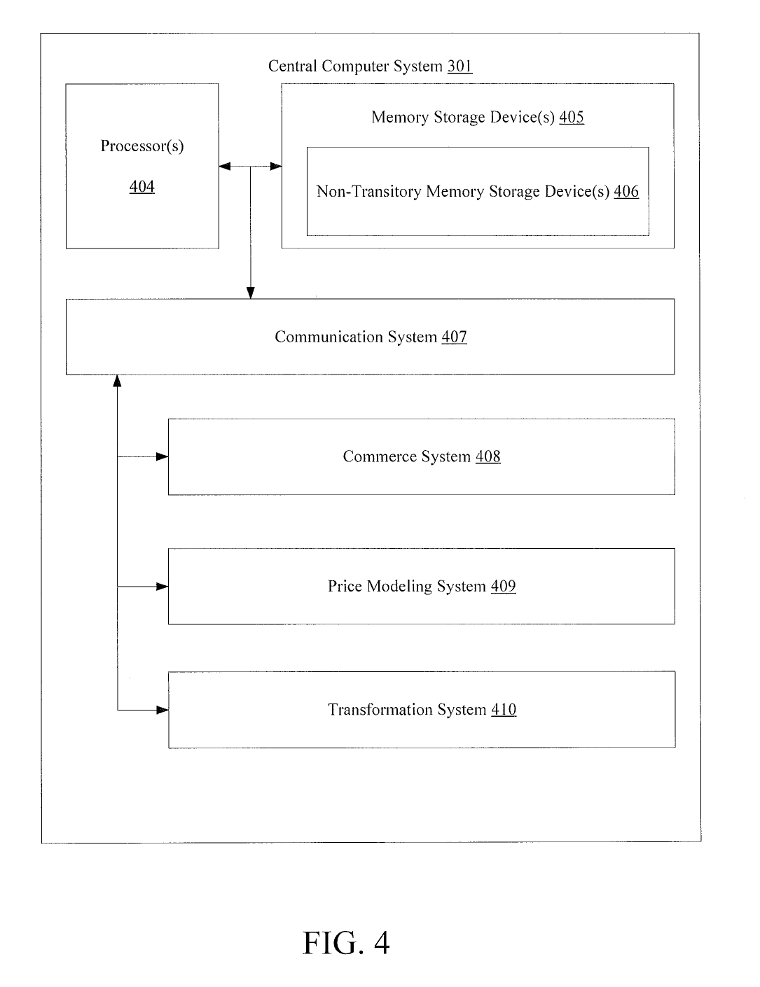

Turning ahead now in the drawings, FIG. 4 illustrates a representative block diagram of central computer system 301, according to the embodiment of FIG. 3; and FIG. 5 illustrates a representative block diagram of database(s) 320, according to the embodiment of FIG. 3.

Referring first to FIG. 4, in many embodiments, central computer system 301 can comprise one or more processors 404, one or more memory storage devices 405, a communication system 407, a commerce system 408, a price modeling system 409, and a transformation system 410. Further, memory storage device(s) 405 can comprise non-transitory memory storage device(s) 406. In some embodiments, part or all of at least one or more of communication system 407, commerce system 408, price modeling system 409, and transformation system 410 can be part of at least one or more others of communication system 407, commerce system 408, price modeling system 409, and transformation system 410, and vice versa.

Meanwhile, referring briefly to FIG. 5, in many embodiments, database(s) 320 can comprise inventory database(s) 521 and transaction history database(s) 522. In some embodiments, part or all of at least one or more of inventory database(s) 521 or transaction history database(s) 522 can be part of the other of inventory database(s) 521 and transaction history database(s) 522, and vice versa.

Returning now to FIG. 4, in many embodiments, processor(s) 404 can be similar or identical to the processor(s) described above with respect to computer system 100 (FIG. 1) and/or central computer system 301 (FIG. 3); memory storage device(s) 405 can be similar or identical to the memory storage device(s) described above with respect to computer system 100 (FIG. 1) and/or central computer system 301 (FIG. 3); and/or non-transitory memory storage device(s) 406 can be similar or identical to the non-transitory memory storage device(s) described above with respect to computer system 100 (FIG. 1) and/or central computer system 301 (FIG. 3). Further, communication system 407, commerce system 408, price modeling system 409, and transformation system 410 can be implemented with hardware and/or software, as desirable. Although communication system 407, commerce system 408, price modeling system 409, and transformation system 410 are shown at FIG. 4 as being separate from processor(s) 404, memory storage device(s) 405, and/or non-transitory memory storage device(s) 406, in many embodiments, part or all of communication system 407, commerce system 408, price modeling system 409, and transformation system 410 can be stored at memory storage device(s) 405 and/or non-transitory memory storage device(s) 406 and can be called and run at processor(s) 404, such as, for example, when the part or all of communication system 407, commerce system 408, price modeling system 409, and transformation system 410 are implemented as software.

### Communication System 407

Communication system 407 is operable to provide and manage communication between the various elements of central computer system 301 (e.g., processor(s) 404, memory storage device(s) 405, non-transitory memory storage device(s) 406, commerce system 408, price modeling system 409, and transformation system 410, etc.) and manage incoming and outgoing communications between central computer system 301 (FIG. 3) and consumer computer system(s) 302 of FIG. 3 (e.g., consumer computer system 303 (FIG. 3)) and/or database(s) 320 (FIG. 3). Like the communications between central computer system 301 (FIG. 3), consumer computer system(s) 302 (FIG. 3), and/or database(s) 320 (FIG. 3), communication system 407 can be implemented using any suitable manner of wired and/or wireless communication, and/or using any one or any combination of wired and/or wireless communication network topologies and/or protocols, as described above with respect to the central computer system 301 (FIG. 3), consumer computer system(s) 302 (FIG. 3), and/or database(s) 320 (FIG. 3). In many embodiments, communication system 407 can be part of hardware and/or software implemented for communications between central computer system 301 (FIG. 3), consumer computer system(s) 302 (FIG. 3), and/or database(s) 320 (FIG. 3). For example, as applicable, communication system 407 can permit processor(s) 404 to call (i) software (e.g., at least part of commerce system 408, price modeling system 409, and transformation system 410, etc.) stored at memory storage device(s) 405 and/or non-transitory memory storage device(s) 406, and/or (ii) data stored at memory storage device(s) 405, at non-transitory memory storage device(s) 406, and/or in database(s) 320 (FIG. 3).

### Commerce System 408

Commerce system 408 is operable to implement electronic commerce with a consumer. In many embodiments, the consumer can comprise an instant consumer as explained in greater detail below with respect to price modeling system 409.

For example, commerce system 408 can make available items that the consumer may electronically browse and purchase, such as, for example, using consumer computer system 303 (FIG. 3). In many embodiments, the items made available by commerce system 408 can comprise any salable items. Exemplary items can comprise goods, services, tickets, real property, intellectual property, etc.

In many embodiments, commerce system 408 can generate, provide, and maintain an electronic interface (e.g., virtual store) to make available to the consumer the items that the consumer may electronically browse and purchase. For example, in some embodiments, commerce system 408 can organize and arrange the items in order to facilitate browsing of the items by the consumer. Further, in various embodiments, commerce system 408 can provide information about the items to inform the consumer about the items. Meanwhile, in further embodiments, commerce system 408 can administer transactions with the consumer in order to permit the consumer to purchase the items. For example, commerce system 408 can provide an electronic shopping cart to hold one or more items of interest to the consumer and can receive monetary payments from the consumer as payment for any items purchased.

In many embodiments, an inventory of the items made available to the consumer for browsing and purchase can be stored at inventory database(s) 521 (FIG. 5). In these or other embodiments, commerce system 408 can reference inventory database(s) 521 (FIG. 5) to populate and maintain the electronic interface with the items made available for browsing and purchase by the consumer. Further, commerce system 408 can update inventory database(s) 521 (FIG. 5) when items of the inventory are sold.

Further, in many embodiments, to facilitate browsing of the items made available to the consumer for browsing and purchase, commerce system 408 can permit the consumer to search for one or more specific items of the items. For example, in these or other embodiments, commerce system 408 can permit the consumer to enter search queries at a search field of the electronic interface.

In these or other embodiments, the inventory stored at inventory database(s) 521 (FIG. 5) can be indexed such that search queries can be associated with one or more specific items of the items available for browsing and purchase by the consumer. Accordingly, when commerce system 408 receives a search query at the search field of the electronic interface, commerce system 408 can reference inventory database(s) 521 (FIG. 5) to identify one or more specific items associated with the search query as search query results. Then, commerce system 408 can communicate (e.g., display) the search query results to the consumer, such as, for example, at a display of consumer computer system 303 (FIG. 3).

In many embodiments, the search query results can be communicated (e.g., displayed) to the consumer as a list. The list can be provided in any suitable arrangement ordering the items (e.g., a serial list, a grid list, etc.). In some embodiments, the consumer can select the arrangement in which the search query results are listed by commerce system 408.

In many embodiments, commerce system 408 can cause the search query results to be filtered so that the search query results are ordered in the list according to one or more filtering parameters. As explained in greater detail below, commerce system 408 can instruct transformation system 410 to transform the search query results according to the desired filtering parameters, and transformation system 410 can provide the transformed search query results to commerce system 408 so that commerce system 408 can communicate (e.g., display) the transformed search query results to the consumer. In some embodiments, one or more of the filtering parameters applied to the search query results can be predetermined. In these or other embodiments, one or more of the filtering parameters applied to the search query results can be selected by the consumer.

In implementation, commerce system 408 can communicate with the consumer and/or consumer computer system 303 (FIG. 3) via communication system 407. Further, commerce system 408 can also communicate with price modeling system 409, transformation system 410, and inventory database(s) 521 (FIG. 5) via communication system 407.

### Price Modeling System 409

Price modeling system 409 is operable to determine one or more estimated price ranges. In many embodiments, the estimated prices range(s) can be associated with one or more search queries provided to commerce system 408 by an instant consumer.

For convenience, price modeling system 409 is generally described as associating one estimated price range with one search query. However, in many embodiments, price modeling system 409 may associate an estimated price range with multiple search queries, such as, for example, where multiple search queries are similar to each other. In these or other embodiments, any suitable standards can be implemented for establishing whether two or more search queries are sufficiently alike with one another to be considered similar to each other. For example, in some embodiments, two or more search queries can be considered similar where the two or more search queries include common terms differing in spelling or order, include terms that are synonyms, include terms with common roots, etc.

Meanwhile, the term “instant consumer” is used to help explain the functionality of price modeling system 409 and refers to a consumer presently interfacing with system 300 (FIG. 3) and/or commerce system 408. Accordingly, an instant consumer can be distinguished from previous consumers (i.e., consumers who previously interfaced with system 300 (FIG. 3) and/or commerce system 408).

In many embodiments, price modeling system 409 can identify the amounts that previous consumers paid for items after providing a particular search query to commerce system 408. In these or other embodiments, price modeling system 409 can store at transaction history database(s) 522 (FIG. 5) the previous amounts paid and the search query associated the previous amounts paid. Then, price modeling system 409 can reference transaction history database(s) 522 (FIG. 5) to define the estimated price range for the search query based on the range of previous prices paid. In many embodiments, price modeling system 409 can repeat these activities for differing search queries to define estimated price ranges for the differing search queries. In these or other embodiments, each estimated price range can be stored at transaction history database(s) 522 (FIG. 5) and can be associated with the search query that is related to that estimated price range.

In many embodiments, price modeling system 409 can update transaction history database(s) 522 (FIG. 5) with new previous amounts paid by previous consumers as previous consumers make additional purchases. Meanwhile, price modeling system 409 can update the estimated price ranges using the new previous amounts paid. In some embodiments, price modeling system 409 can reference transaction history database(s) 522 (FIG. 5) to determine whether one or more estimated price ranges can be updated. For example, price modeling system 409 can reference transaction history database(s) 522 (FIG. 5) to determine whether new previous amounts paid by previous consumers have been stored at transaction history database(s) 522 (FIG. 5) which can be used to update the estimated price range. In some embodiments, price modeling system 409 can reference transaction history database(s) 522 (FIG. 5) to determine whether estimated price ranges can be updated at a predetermined and/or regular interval of time (e.g., hourly, daily, etc.). In these or other embodiments, price modeling system 409 can reference transaction history database(s) 522 (FIG. 5) to determine whether an estimated price range can be updated when commerce system 408 receives a search query from an instant consumer (e.g., responsive to commerce system 408 receiving the search query from the instant consumer). The frequency and manner with which price modeling system 409 updates the estimated price ranges can be governed by the computing resources available to implement system 300 (FIG. 3) and/or price modeling system 409.

In some embodiments, when determining an estimated price range, price modeling system 409 can improve the accuracy of the estimated price range by collecting the previous prices paid by previous consumers over a period of time and applying a moving average to the previous prices paid. In particular, the period of time can be divided into multiple intervals of time such that previous prices paid by previous consumers during each interval of time are associated with that interval of time. In these or other embodiments, more recent intervals of time (e.g., more recent previous prices paid by previous consumers) can be given more weight under the moving average than less recent intervals of time (e.g., less recent previous prices paid by previous consumers). By collecting the previous prices over a period of time, the estimated price range can better establish a payment trend and reduce the risk that temporary fluctuations in previous prices paid will result in an inaccurate estimated price range. Meanwhile, by discounting older previous prices paid, price modeling system 409 can ensure that the estimated price range favors the current payment trend. The period of time over which the previous prices paid are considered in determining the estimated price range can be any suitable period of time. Likewise, the intervals at which the moving average is applied can be any suitable fraction (e.g., regular fraction) of the period of time. For example, in many embodiments, the period of time can be 90 days, and the interval of the period of time can be one day.

Further, when an insufficient number of previous prices paid within a particular interval of the period of time are collected, the previous prices of that interval of the period of time can be excluded from consideration in determining an estimated price range. For example, in some embodiments, when less than ten previous prices paid are collected for a particular interval of the period of time, the previous prices of that interval of the period of time can be excluded from consideration in determining an estimated price range.

In these or other embodiments, when determining an estimated price range, price modeling system 409 can improve the accuracy of the estimated price range by excluding outlying previous prices paid by previous consumers when determining an estimated price range. For example, in some embodiments, during each interval of the period of time for which previous prices paid are collected, a percentage of the highest and lowest values can be excluded from consideration when determining the estimated price range. In a specific example, 2.5 percent of the highest previous prices paid and 2.5 percent of the lowest previous prices paid can be excluded such that only 95 percent of the previous prices paid are considered when determining the estimated price range.

In implementation, price modeling system 409 can communicate with transaction history database(s) 522 (FIG. 5) via communication system 407.

### Transformation System 410

Transformation system 410 can be operable to identify one or more in-range items and one or more out-range items of the search query results associated with search queries provided by an instant consumer to commerce system 408. In many embodiments, in-range items can refer to items having prices included by the estimated price range that price modeling system 409 determines for the search query. For example, in-range items can include items having prices greater than or equal to the minimum value of the estimated price range and items having prices less than or equal to the maximum value of the estimated price range. Meanwhile, in these or other embodiments, out-range items can refer to items falling outside of the estimate price range. For example, out-range items can include items having prices greater than the maximum value of the estimated price range and having prices less than the minimum value of the estimated price range.

Further, transformation system 410 can be operable to transform the search query results associated with the search query provided by the instant consumer to commerce system 408 such that one or more (e.g., all) of the in-range item(s) are listed before one or more (e.g., all) of the out-range item(s) in the list of search query results. That is, transformation system 410 can filter the search query results associated with the search query so that items of the search query results having prices closer to the estimated price range are ordered ahead of items of the search query results having prices farther from the estimated price range. In these or other embodiments, commerce system 408 can instruct transformation system 410 to apply an estimated price range filter parameter to the search query results to cause transformation system 410 to transform the search query results associated with the search query provided by the instant consumer to commerce system 408 such that one or more (e.g., all) of the in-range item(s) are listed before one or more (e.g., all) of the out-range item(s) in the list of search query results. In many embodiments, transforming the search query results associated with the search query provided by the instant consumer to commerce system 408 (such that one or more (e.g., all) of the in-range item(s) are listed before one or more (e.g., all) of the out-range item(s) in the list of search query results) can optimize search query results provided to the instant consumer according to historic consumer payment behavior modeled by price modeling system 409.

In many embodiments, transformation system 410 can transform the search query results one or more (e.g., all) of the in-range item(s) are listed before one or more (e.g., all) of the out-range item(s) in the list of search query results by scoring each item of the search query results with respect to the estimated price range of the search query and by ordering each item of the search query results according to the scores. In these or other embodiments, transformation system 410 can score the search query results using a distance function with respect to the estimated price range of the search query. For example, in many embodiments, transformation system 410 can score the search query results using the distance function of equation (1) as follows:

$$D = \frac{( \vert {p}_{max} - {p}_{min} \vert )}{( \vert {p}_{max} - {p}_{i} \vert + \vert {p}_{i} - {p}_{min} \vert )} , \qquad ( 1 )$$

where D is the distance of the price of an item (pᵢ) of the search query results from the estimated price range of a search query having a maximum price (pₘₐₓ) and a minimum price (pₘᵢₙ). In these embodiments, in-range items can score a 1, and out-range items can score between 0 and 1. Accordingly, items of the search query results can be ordered by score where higher scoring items of the search query results are ordered ahead of lower scoring items of the search query results.

In some embodiments, out-range items scoring below a minimum threshold score of the distance function can be considered to have the minimum threshold score of the distance function. For example, the minimum threshold score of the distance function can be a predetermined score between 0 and 1. In specific examples, the minimum threshold score can be 0.2, 0.4, 0.6, or 0.8. Applying a minimum threshold score to the out-range items can limit the weight of the estimated price range on the order of the search query results when one or more filter parameters other than the estimated price range filter parameter are additionally applied to the search query results.

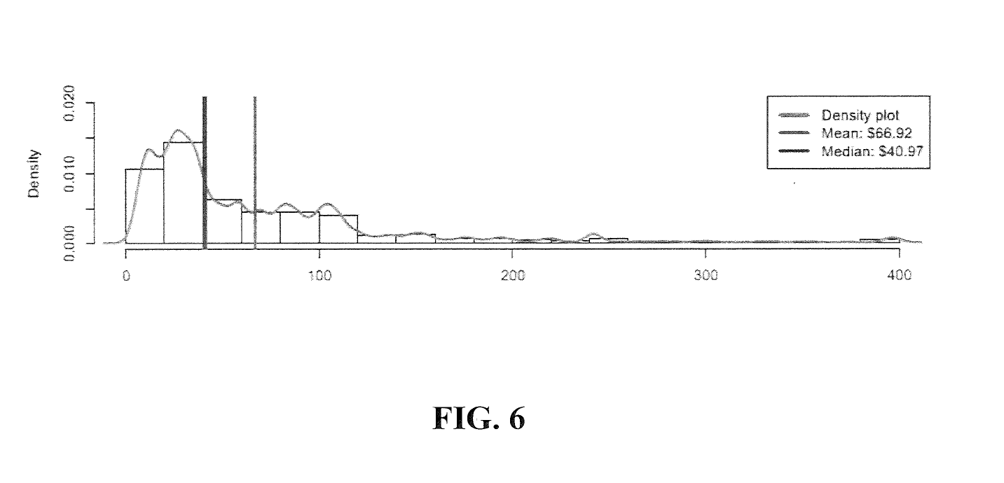

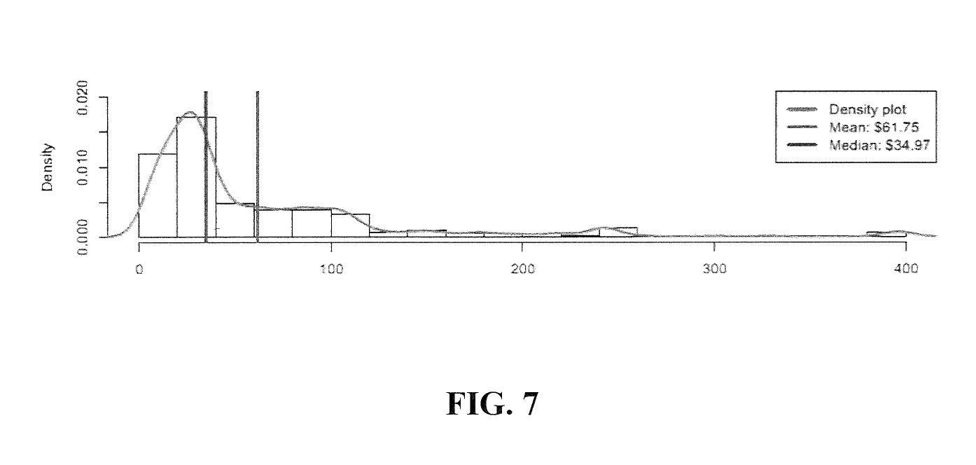

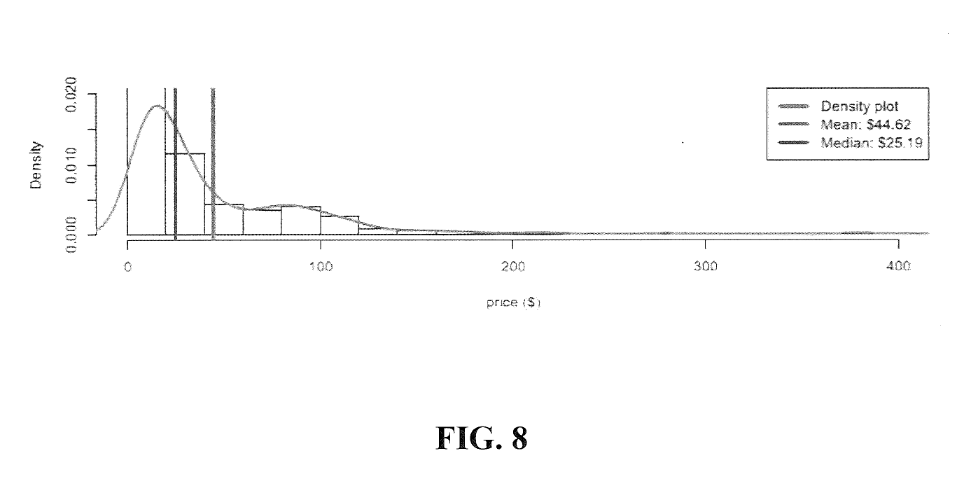

In many embodiments, commerce system 408 instructing transformation system 410 to apply an estimated price range filter can be advantageous to the instant consumer providing the search query by providing items of the search query results included within a price range of prices that are most relevant to the average consumer. Accordingly, the search query results provided to the instant consumer are likely to also be more relevant to the instant consumer. Indeed, turning ahead in the drawings, FIG. 6-8 illustrate that the amounts paid by previous consumers may differ from the prices of items that previous consumers viewed or clicked. Specifically, FIG. 6 illustrates a graph of an exemplary density of items viewed by previous consumers for a particular search query as a function of the price of the items; FIG. 7 illustrates a graph of an exemplary density of items clicked by previous consumers for the particular search query as a function of the price of the items; and FIG. 8 illustrates a graph of an exemplary density of items purchased by previous consumers for the particular search query as a function of the price of the items. Meanwhile, FIGS. 6-8 also provide the mean and median prices of the items, which indicate that the mean and median prices of items purchased at FIG. 8 are different than the mean and median prices of items viewed and clicked at FIGS. 6 and 7.

Returning again to FIG. 4, as noted previously above, in many embodiments, commerce system 408 can instruct transformation system 410 to apply one or more filter parameters to the search query results other than an estimated price range filter parameter. Similar to when applying the estimated price range filter parameter, transformation system 410 can score the search query results according to the other filter parameter(s) by applying one or more filter functions corresponding to the other filter parameter(s). Exemplary filter functions can include numeric sorting functions, alphabetical sorting functions, etc.

In some embodiments, commerce system 408 can instruct transformation system 410 to apply one or more other filter parameters to (i) all of the search query results, (ii) only the in-range items of the search query results, and/or (iii) only the out-range items of the search query results. In many embodiments, applying one or more other filter parameters to the in-range items can be advantageous because all in-range items have the same score when filtered under the estimated price range filter parameter. Therefore, applying the other filter parameter(s) to the in-range products can help to further refine the relevance of the search query results for the instant consumer.

In many embodiments, any suitable filter parameters can be applied to search query results. Exemplary filter parameters can comprise a relevant-to-query filter parameter, a low-to-high price filter parameter, a high-to-low price filter parameter, a customer review filter parameter, a brand filter parameter, or a recency of offering filter parameter. In particular, a relevant-to-query filter parameter can filter the search query results according to a closeness of the search query to the name of the items of the search query results; a low-to-high price filter parameter can filter the search query results according to a lowest to highest price of the items of the search query results; a high-to-low price filter parameter can filter the search query results according to a highest to lowest price of the items of the search query results; a customer review filter parameter can filter the search query results according to an average rating (highest to lowest or lowest to highest) of the items provided by previous consumers; a brand filter parameter can fitter the search query results according to a brand of the items of the search query results; and a recency of offering filter parameter can filter the search query results according to how recently the items of the search query results were offered for sale.

In these or other embodiments, one or more out-range items can be listed ahead of one or more in-range items in the list of search query results, such as, for example, when one or more of the out-range items have higher priority than one or more of the in-range items when considering all of the relevant filter parameters applied to the search query results. In many embodiments, transformation system 410 can assign the same or different weights to the filter parameters. When transformation system 410 assigns different weights to the filter parameters, the impact of one or more filter parameters on the order of the items in the search query results can be greater than the impact of one or more other filter parameters on the order of the items in the search query results.

In implementation, transformation system 410 can communicate with price modeling system 409 via communication system 407.

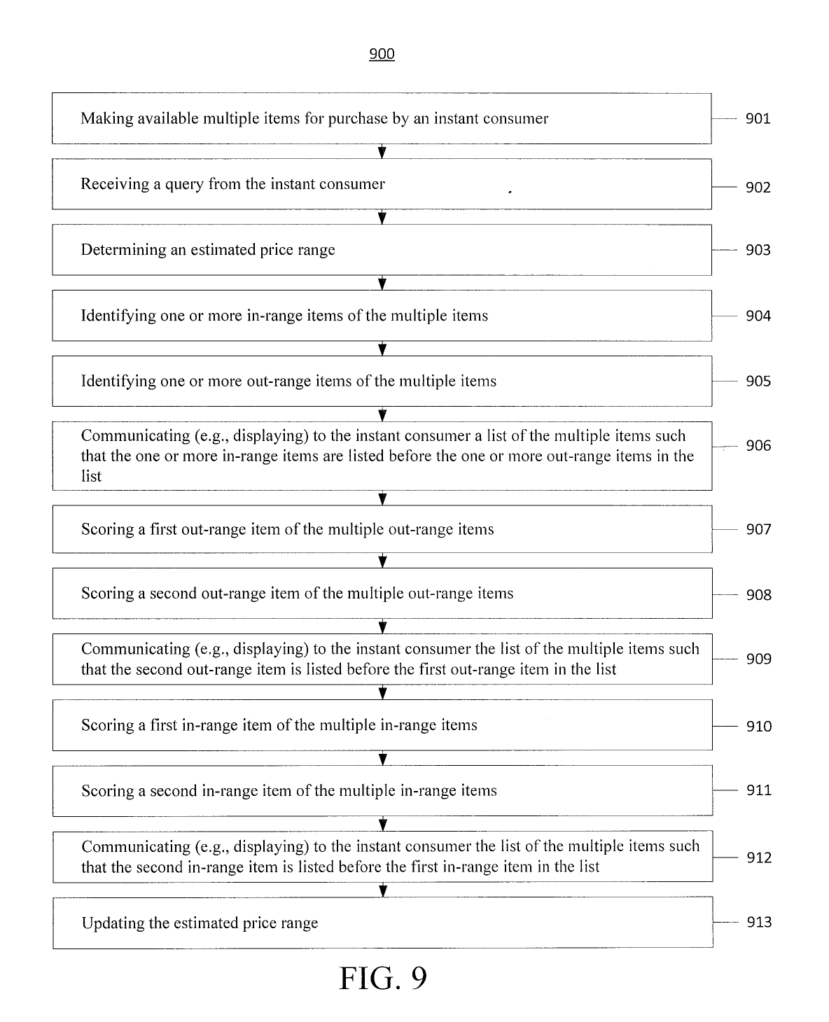

Turning ahead in the drawings, FIG. 9 illustrates a flow chart for a method 900, according to an embodiment. Method 900 is merely exemplary and is not limited to the embodiments presented herein. Method 900 can be employed in many different embodiments or examples not specifically depicted or described herein. In some embodiments, the activities of method 900 can be performed in the order presented. In other embodiments, the activities of method 900 can be performed in any suitable order. In still other embodiments, one or more of the activities of method 900 can be combined or skipped. In many embodiments, central computer system 301 (FIG. 3) can be suitable to perform method 900 and/or one or more of the activities of method 900. In these or other embodiments, one or more of the activities of method 900 can be implemented as one or more computer instructions configured to run at one or more processors and configured to be stored at one or more non-transitory memory storage devices. The processor(s) can be similar or identical to the processor(s) described above with respect to computer system 100 (FIG. 1) and/or to processor(s) 404 (FIG. 4). Further, the non-transitory memory storage device(s) can be similar or identical to the non-transitory memory storage device(s) described above with respect to computer system 100 (FIG. 1) and/or to non-transitory memory storage device(s) 406 (FIG. 4).

In many embodiments, method 900 can comprise activity 901 of making available multiple items for purchase by an instant consumer. In some embodiments, performing activity 901 can be similar or identical to making available multiple items for purchase by an instant consumer as described above with respect to system 300 (FIG. 3) and/or commerce system 408 (FIG. 4). Further, the multiple items can be similar or identical to one or more of the items made available for browsing and purchase as described above with respect to system 300 (FIG. 3) and/or commerce system 408 (FIG. 4). Meanwhile, the instant consumer can be similar or identical to an instant consumer as described above with respect to system 300 (FIG. 3) and/or price modeling system 409 (FIG. 4).

In many embodiments, method 900 can comprise activity 902 of receiving a query from the instant consumer. In some embodiments, performing activity 902 can be similar or identical to receiving a query from the instant consumer as described above with respect to system 300 (FIG. 3) and/or commerce system 408 (FIG. 4). Further, the query can be similar or identical to a search query as described above with respect to system 300 (FIG. 3) and/or commerce system 408 (FIG. 4).

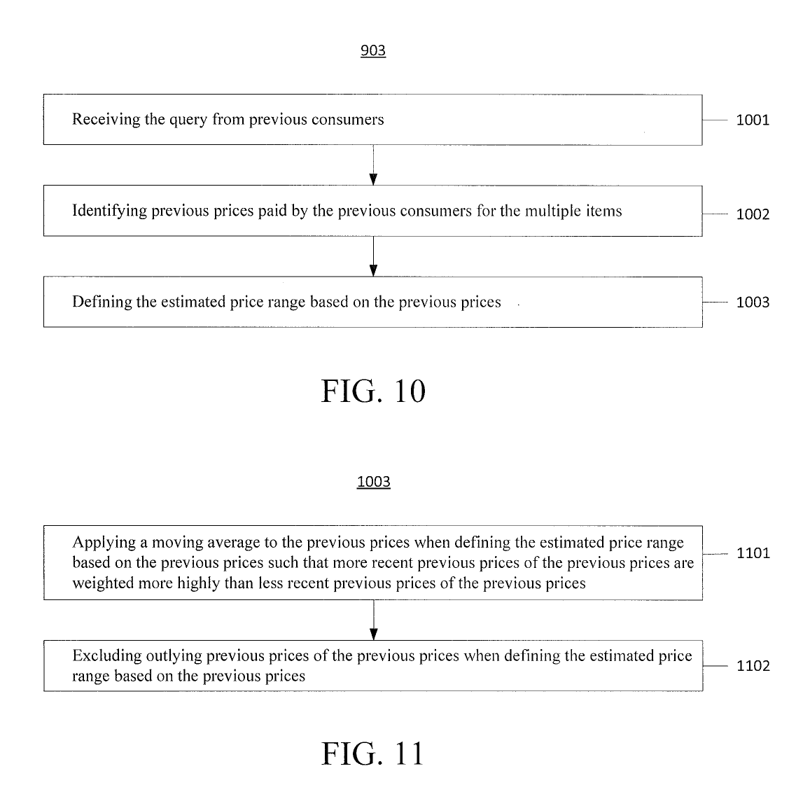

In many embodiments, method 900 can comprise activity 903 of determining an estimated price range. In some embodiments, performing activity 903 can be similar or identical to determining an estimated price range as described above with respect to system 300 (FIG. 3) and/or price modeling system 409 (FIG. 4). Further, the estimated price range can be similar or identical to an estimated price range as described above with respect to system 300 (FIG. 3) and/or price modeling system 409 (FIG. 4). FIG. 10 illustrates an exemplary activity 903, according to the embodiment of FIG. 9.

For example, activity 903 can comprise activity 1001 of receiving the query from previous consumers. In some embodiments, performing activity 1001 can be similar or identical to receiving the query from previous consumers as described above with respect to system 300 (FIG. 3) and/or price modeling system 409 (FIG. 4). Further, the previous consumers can be similar or identical to previous consumers as described above with respect to system 300 (FIG. 3) and/or price modeling system 409 (FIG. 4).

Further, activity 903 can comprise activity 1002 of identifying previous prices paid by the previous consumers for the multiple items. In some embodiments, performing activity 1002 can be similar or identical to identifying previous prices paid by the previous consumers for the multiple items as described above with respect to system 300 (FIG. 3) and/or price modeling system 409 (FIG. 4). Further, the previous prices can be similar or identical to previous prices as described above with respect to system 300 (FIG. 3) and/or price modeling system 409 (FIG. 4).

In these or other embodiments, activity 1002 can comprise an activity of identifying the previous prices over a period of time. In some embodiments, the period of time can be similar or identical to the period of time as described above with respect to system 300 (FIG. 3) and/or price modeling system 409 (FIG. 4).

Further still, activity 903 can comprise activity 1003 of defining the estimated price range based on the previous prices. In some embodiments, performing activity 1003 can be similar or identical to defining the estimated price range based on the previous prices as described above with respect to system 300 (FIG. 3) and/or price modeling system 409 (FIG. 4). FIG. 11 illustrates an exemplary activity 1003, according to the embodiment of FIG. 9.

For example, activity 1003 can comprise activity 1101 of applying a moving average to the previous prices when defining the estimated price range based on the previous prices such that more recent previous prices of the previous prices are weighted more highly than less recent previous prices of the previous prices. In some embodiments, performing activity 1101 can be similar or identical to applying a moving average to the previous prices when defining the estimated price range based on the previous prices such that more recent previous prices of the previous prices are weighted more highly than less recent previous prices of the previous prices as described above with respect to system 300 (FIG. 3) and/or price modeling system 409 (FIG. 4).

Further, activity 1003 can comprise activity 1102 of excluding outlying previous prices of the previous prices when defining the estimated price range based on the previous prices. In some embodiments, performing activity 1102 can be similar or identical to excluding outlying previous prices of the previous prices when defining the estimated price range based on the previous prices as described above with respect to system 300 (FIG. 3) and/or price modeling system 409 (FIG. 4).

Referring back to FIG. 9, in many embodiments, method 900 can comprise activity 904 of identifying one or more in-range items of the multiple items. In some embodiments, performing activity 904 can be similar or identical to identifying one or more in-range items of the multiple items as described above with respect to system 300 (FIG. 3) and/or transformation system 410 (FIG. 4). Further, the in-range items can be similar or identical to the in-range items as described above with respect to system 300 (FIG. 3) and/or transformation system 410 (FIG. 4).

In many embodiments, method 900 can comprise activity 905 of identifying one or more out-range items of the multiple items. In some embodiments, performing activity 905 can be similar or identical to identifying one or more out-range items of the multiple items as described above with respect to system 300 (FIG. 3) and/or transformation system 410 (FIG. 4). Further, the out-range items can be similar or identical to the out-range items as described above with respect to system 300 (FIG. 3) and/or transformation system 410 (FIG. 4).

In many embodiments, method 900 can comprise activity 906 of communicating (e.g., displaying) to the instant consumer a list of the multiple items such that the one or more in-range items are listed before the one or more out-range items in the list. In some embodiments, performing activity 906 can be similar or identical to communicating (e.g., displaying) to the instant consumer a list of the multiple items such that the one or more in-range items are listed before the one or more out-range items in the list as described above with respect to system 300 (FIG. 3), commerce system 408 (FIG. 4), and/or transformation system 410 (FIG. 4). Further, the list can be similar or identical to a list as described above with respect to system 300 (FIG. 3) and/or commerce system 408 (FIG. 4).

In some embodiments, when the out-range item(s) comprise multiple out-range items, method 900 can comprise (i) activity 907 of scoring a first out-range item of the multiple out-range items, (ii) activity 908 of scoring a second out-range item of the multiple out-range items, and (iii) activity 909 of communicating (e.g., displaying) to the instant consumer the list of the multiple items such that the second out-range item is listed before the first out-range item in the list. In some embodiments, performing activity 907 can be similar or identical to scoring a first out-range item of the multiple out-range items as described above with respect to system 300 (FIG. 3) and/or transformation system 410 (FIG. 4). Further, performing activity 908 can be similar or identical to scoring a second out-range item of the multiple out-range items as described above with respect to system 300 (FIG. 3) and/or transformation system 410 (FIG. 4). Further still, performing activity 909 can be similar or identical to communicating (e.g., displaying) to the instant consumer the list of the multiple items such that the second out-range item is listed before the first out-range item in the list as described above with respect to system 300 (FIG. 3), commerce system 408 (FIG. 4), and/or transformation system 410 (FIG. 4).

For example, in many embodiments, activity 907 can comprise an activity of applying the first out-range item price to a distance function of the estimated price range. Meanwhile, activity 908 can comprise an activity of applying the second out-range item price to the distance function of the estimated price range to determine the second out-range item price is closer to the estimated price range than is the first out-range item price.

In some embodiments, performing activity 907 can be similar or identical to applying the first out-range item price to a distance function of the estimated price range as described above with respect to system 300 (FIG. 3) and/or transformation system 410 (FIG. 4). In these or other embodiments, performing activity 908 can be similar or identical to applying the second out-range item price to the distance function of the estimated price range to determine the second out-range item price is closer to the estimated price range than is the first out-range item price as described above with respect to system 300 (FIG. 3) and/or transformation system 410 (FIG. 4). Further, the distance function can be similar or identical to the distance function described above with respect to system 300 (FIG. 3) and/or transformation system 410 (FIG. 4).

In some embodiments, when the in-range item(s) comprise multiple in-range items, method 900 can comprise (i) activity 910 of scoring a first in-range item of the multiple in-range items, (ii) activity 911 of scoring a second in-range item of the multiple in-range items, and (iii) activity 912 of communicating (e.g., displaying) to the instant consumer the list of the multiple items such that the second in-range item is listed before the first in-range item in the list. In some embodiments, performing activity 910 can be similar or identical to scoring a first in-range item of the multiple in-range items as described above with respect to system 300 (FIG. 3) and/or transformation system 410 (FIG. 4). Further, performing activity 911 can be similar or identical to scoring a second in-range item of the multiple in-range items as described above with respect to system 300 (FIG. 3) and/or transformation system 410 (FIG. 4). Further still, performing activity 909 can be similar or identical to communicating (e.g., displaying) to the instant consumer the list of the multiple items such that the second in-range item is listed before the first in-range item in the list as described above with respect to system 300 (FIG. 3), commerce system 408 (FIG. 4), and/or transformation system 410 (FIG. 4).

For example, in many embodiments, activity 910 can comprise an activity of applying a filtering function to the first in-range item. Meanwhile, activity 911 can comprise an activity of applying a filtering function to the second in-range item to determine the second in-range item satisfies a filter parameter more than the first in-range item satisfies the filter parameter.

In some embodiments, performing activity 910 can be similar or identical to applying a filtering function to the first in-range item as described above with respect to system 300 (FIG. 3) and/or transformation system 410 (FIG. 4). In these or other embodiments, performing activity 908 can be similar or identical to applying a filtering function to the second in-range item to determine the second in-range item satisfies a filter parameter more than the first in-range item satisfies the filter parameter as described above with respect to system 300 (FIG. 3) and/or transformation system 410 (FIG. 4). Further, the filter function can be similar or identical to any of the filter functions described above with respect to system 300 (FIG. 3) and/or transformation system 410 (FIG. 4), and the filter parameter can be similar or identical any of the filter parameters described above with respect to system 300 (FIG. 3) and/or transformation system 410 (FIG. 4).

In many embodiments, method 900 can comprise activity 913 of updating the estimated price range. In some embodiments, performing activity 913 can be similar or identical to updating the estimated price range as described above with respect to system 300 (FIG. 3) and/or price modeling system 409 (FIG. 4). In further embodiments, activity 913 can be performed after activity 903.

In some embodiments, one or more of activities 902-913 can be performed simultaneously with activity 901. In many embodiments, one or more of activities 903-913 can be performed after activity 902. In other embodiments, activity 903 can be performed before or approximately simultaneously with activity 902.

Meanwhile, in many embodiments, one or more of activities 901-912 can be repeated one or more times. In some embodiments, one or more of activities 901-912 can be repeated one or more times but for one or more different search queries and/or items associated with those search queries.

Although extending an existing item taxonomy has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-11 may be modified, and that the foregoing discussion of certain of these embodiments does not necessarily represent a complete description of all possible embodiments. For example, one or more of the activities of FIGS. 9-11 may include different activities and be performed by many different modules, in many different orders. As another example, the modules within central computer system 301 in FIG. 3 can be interchanged or otherwise modified.

Generally, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1) A system comprising:
one or more processors; and
one or more non-transitory memory storage devices storing computer instructions configured to run on the one or more processors and perform acts of:
making available multiple items for purchase by an instant consumer;
receiving a query from the instant consumer, the query being associated with the multiple items;
determining an estimated price range;
identifying one or more in-range items of the multiple items, the one or more in-range items having one or more in-range item prices, and the estimated price range including the one or more in-range item prices;
identifying one or more out-range items of the multiple items, the one or more out-range items having one or more out-range item prices, and the one or more out-range item prices being outside of the estimated price range; and
facilitating displaying to the instant consumer a list of the multiple items such that the one or more in-range items are listed before the one or more out-range items in the list.

2) The system of claim 1 wherein:
determining the estimated price range comprises:
receiving the query from previous consumers;
identifying previous prices paid by the previous consumers for the multiple items; and
defining the estimated price range based on the previous prices.

3) The system of claim 2 wherein:
identifying the previous prices comprises:
identifying the previous prices over a period of time;
and
defining the estimated price range based on the previous prices comprises:
applying a moving average to the previous prices when defining the estimated price range based on the previous prices such that more recent previous prices of the previous prices are weighted more highly than less recent previous prices of the previous prices.

4) The system of claim 2 wherein:
defining the estimated price range based on the previous prices comprises:
excluding outlying previous prices of the previous prices when defining the estimated price range based on the previous prices.

5) The system of claim 1 wherein:
the one or more out-range items comprise multiple out-range items;
the acts further comprise:
scoring a first out-range item of the multiple out-range items, the first out-range item of the multiple out-range items having a first out-range item price;
scoring a second out-range item of the multiple out-range items, the second out-range item of the multiple out-range items having a second out-range item price;
and
facilitating displaying to the instant consumer the list of the multiple items such that the second out-range item is listed before the first out-range item in the list;
scoring the first out-range item of the multiple out-range items comprises:
applying the first out-range item price to a distance function of the estimated price range;
and
scoring a second out-range item of the multiple out-range items comprises:
applying the second out-range item price to the distance function of the estimated price range to determine the second out-range item price is closer to the estimated price range than is the first out-range item price.

6) The system of claim 1 wherein:
the one or more in-range items comprise multiple in-range items;
the acts further comprise:
scoring a first in-range item of the multiple in-range items;
scoring a second in-range item of the multiple in-range items;
and
facilitating displaying to the instant consumer the list of the multiple items such that the second in-range item is listed before the first in-range item in the list;
scoring the first in-range item of the multiple in-range items comprises:
applying a filtering function to the first in-range item;
and
scoring the second in-range item of the multiple in-range items comprises:
applying a filtering function to the second in-range item to determine the second in-range item satisfies a filter parameter more than the first in-range item satisfies the filter parameter.

7) The system of claim 6 wherein:
the filter parameter comprises one of:
a relevant-to-query filter parameter;
a low-to-high price filter parameter;
a high-to-low price filter parameter;
a customer review filter parameter;
a brand filter parameter; or
a recency of offering filter parameter.

8) The system of claim 1 wherein the acts further comprise:
after determining the estimated price range, updating the estimated price range.

9) A method comprising:
executing one or more first computer instructions configured to make available multiple items for purchase by an instant consumer;
executing one or more second computer instructions configured to receive a query from the instant consumer, the query being associated with the multiple items;
executing one or more third computer instructions configured to determine an estimated price range;
executing one or more fourth computer instructions configured to identify one or more in-range items of the multiple items, the one or more in-range items having one or more in-range item prices, and the estimated price range including the one or more in-range item prices;
executing one or more fifth computer instructions configured to identify one or more out-range items of the multiple items, the one or more out-range items having one or more out-range item prices, and the one or more out-range item prices being outside of the estimated price range; and
executing one or more sixth computer instructions configured to communicate to the instant consumer a list of the multiple items such that the one or more in-range items are listed before the one or more out-range items in the list;
wherein:
the one or more first computer instructions, the one or more second computer instructions, the one or more third computer instructions, the one or more fourth computer instructions, the one or more fifth computer instructions, and the one or more sixth computer instructions are configured to run at one or more processors and configured to be stored at one or more non-transitory memory storage devices.

10) The method of claim 9 wherein:
executing the one or more third computer instructions comprises:
executing one or more seventh computer instructions configured to receive the query from previous consumers;
executing one or more eighth computer instructions configured to identify previous prices paid by the previous consumers for the multiple items; and
executing one or more ninth computer instructions configured to define the estimated price range based on the previous prices.

11) The method of claim 10 wherein:
executing the one or more eighth computer instructions comprises:
executing one or more tenth computer instructions configured to identify the previous prices over a period of time;
and
executing the one or more ninth computer instructions comprises:
executing one or more eleventh computer instructions configured to apply a moving average to the previous prices when defining the estimated price range based on the previous prices such that more recent previous prices of the previous prices are weighted more highly than less recent previous prices of the previous prices.

12) The method of claim 10 wherein:
executing the one or more ninth computer instructions comprises:
executing one or more tenth computer instructions configured to exclude outlying previous prices of the previous prices when defining the estimated price range based on the previous prices.

13) The method of claim 9 wherein:
the one or more out-range items comprise multiple out-range items;
the method further comprises:
executing one or more seventh computer instructions configured to score a first out-range item of the multiple out-range items, the first out-range item of the multiple out-range items having a first out-range item price;
executing one or more eighth computer instructions configured to score a second out-range item of the multiple out-range items;
and
executing one or more ninth computer instructions configured to communicate to the instant consumer the list of the multiple items such that the second out-range item is listed before the first out-range item in the list, the second out-range item scoring higher than the first out-range item;
executing the one or more seventh computer instructions comprises:
executing one or more tenth computer instructions configured to apply the first out-range item price to a distance function of the estimated price range;
executing the one or more eighth computer instructions comprises:
executing one or more eleventh computer instructions configured to apply the second out-range item price to the distance function of the estimated price range to determine the second out-range item price is closer to the estimated price range than is the first out-range item price;
and
the one or more seventh computer instructions, the one or more eighth computer instructions, and the one or more ninth computer instructions are configured to run at one or more processors and configured to be stored at one or more non-transitory memory storage devices.

14) The method of claim 9 wherein:
the one or more in-range items comprise multiple in-range items;
the method further comprises:
executing one or more seventh computer instructions configured to score a first in-range item of the multiple in-range items;
executing one or more eighth computer instructions configured to score a second in-range item of the multiple in-range items;
and
executing one or more ninth computer instructions configured to communicate to the instant consumer the list of the multiple items such that the second in-range item is listed before the first in-range item in the list;
executing the one or more seventh computer instructions comprises:
executing one or more tenth computer instructions configured to apply a filtering function to the first in-range item;
executing the one or more eighth computer instructions comprises:
executing one or more eleventh computer instructions configured to apply a filtering function to the second in-range item to determine the second in-range item satisfies a filter parameter more than the first in-range item satisfies the filter parameter;
and
the one or more seventh computer instructions, the one or more eighth computer instructions, and the one or more ninth computer instructions are configured to run at one or more processors and configured to be stored at one or more non-transitory memory storage devices.

15) The method of claim 9 wherein:
the filter parameter comprises one of:
a relevant-to-query filter parameter;
a low-to-high price filter parameter;
a high-to-low price filter parameter;
a customer review filter parameter;
a brand filter parameter; or
a recency of offering filter parameter.

16) The method of claim 9 further comprising:
after executing the one or more third computer instructions, executing one or more seventh computer instructions configured to update the estimated price range.

17) At least one non-transitory memory storage device having computer instructions stored thereon executable by one or more processors to perform acts of:
making available multiple items for purchase by an instant consumer;
receiving a query from the instant consumer, the query being associated with the multiple items;
determining an estimated price range;
identifying one or more in-range items of the multiple items, the one or more in-range items having one or more in-range item prices, and the estimated price range including the one or more in-range item prices;
identifying one or more out-range items of the multiple items, the one or more out-range items having one or more out-range item prices, and the one or more out-range item prices being outside of the estimated price range; and
facilitating displaying to the instant consumer a list of the multiple items such that the one or more in-range items are listed before the one or more out-range items in the list.

18) The at least one non-transitory memory storage device of claim 17 wherein:
determining the estimated price range comprises:
receiving the query from previous consumers;
identifying previous prices paid by the previous consumers for the multiple items; and
defining the estimated price range based on the previous prices.

19) The at least one non-transitory memory storage device of claim 18 wherein:
identifying the previous prices comprises:
identifying the previous prices over a period of time;
and
defining the estimated price range based on the previous prices comprises:
applying a moving average to the previous prices when defining the estimated price range based on the previous prices such that more recent previous prices of the previous prices are weighted more highly than less recent previous prices of the previous prices; and
excluding outlying previous prices of the previous prices when defining the estimated price range based on the previous prices.

20) The at least one non-transitory memory storage device of claim 19 wherein:
the one or more out-range items comprise multiple out-range items;
the acts further comprise:
scoring a first out-range item of the multiple out-range items, the first out-range item of the multiple out-range items having a first out-range item price;
scoring a second out-range item of the multiple out-range items, the second out-range item of the multiple out-range items having a second out-range item price;
and
displaying to the instant consumer the list of the multiple items such that the second out-range item is listed before the first out-range item in the list;
scoring the first out-range item of the multiple out-range items comprises:
applying the first out-range item price to a distance function of the estimated price range;
and
scoring a second out-range item of the multiple out-range items comprises:
applying the second out-range item price to the distance function of the estimated price range to determine the second out-range item price is closer to the estimated price range than is the first out-range item price.
